(19) United States
(12) Patent Application Publication
(10) Pub. No.: US 2022/0322682 A1
(43) Pub. Date: Oct. 13, 2022

(54) SUPPORT TRAY FOR BAKERY, VIENNOISERIE, PATISSERIE AND SIMILAR PRODUCTS, MADE FROM AN EXPANDED METAL SHEET

(71) Applicant: MECATHERM, Barembach (FR)

(72) Inventors: Jordan OUDOT, Russ (FR); Olivier SERGENT, Paris (FR)

(21) Appl. No.: 17/642,663

(22) PCT Filed: Sep. 15, 2020
(86) PCT No.: PCT/EP2020/075756

§ 371 Date: Mar. 11, 2022

(30) Foreign Application Priority Data
Sep. 17, 2019 (FR) 1910251

(51) Int. Cl. A21B 3/13; A47J 37/01; A47J 36/02

(52) U.S. Cl. CPC A21B 3/132; A47J 37/01; A47J 36/025; A21B 3/139

(57) ABSTRACT

The support tray device for transporting bakery, patisserie, viennoiserie or similar products through at least one processing unit of an installation used for producing such products includes a frame on which at least one sheet of metallic material is fixed. The sheet includes an expanded-metal sheet having micromeshes forming a metal lattice. The expanded-metal sheet is obtained by cutting and stretching a metal sheet. The micromeshes have passage openings between 130 and 750 μm. As a result of the micromeshes, the expanded metal sheet has a voids surface area representing between 17 and 60% of the total surface area of the sheet.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a support tray device in particular for the fermentation, baking, cooling and freezing of bakery, viennoiserie, patisserie or similar products.

The present invention will find its application mainly in the field of utensils and industrial bakery installations.

### 2. Description of Related Art Including Information Disclosed Under 37 CFR 1.97 and 37 CFR 1.98

In this field of application, there are essentially two main families of products, namely:
products that are baked on support trays or in molds;
and products baked directly on the floor of an oven.

Traditionally, regarding the first category of products, the dough initially undergoes a step of dividing into a plurality of dough pieces. Then, a step of shaping the dough pieces may be implemented, before depositing the latter on support trays or in molds.

These support trays will then be used to transport and deliver the dough pieces through the various bakery product processing units that are generally present in an industrial bakery production facility, such as in particular the fermentation, baking, deep-freezing and cooling units.

There are many types of support trays for bakery or similar products; these may also be referred to as baking trays in the remainder of the description.

Thus, in particular, such a support tray may comprise a support material mounted secured to a frame. This then constitutes a framework ensuring the rigidity of the whole of said tray for the handling thereof.

In one particular embodiment, the support material consists of a solid sheet that may in particular be shaped by bending so as to form housings for receiving the dough pieces. A specific shape consists, for example, of an undulation of the support material so as to form recessed housings, also called cells or troughs. This is then referred to as a “dimpled tray,” such a tray being used in the method for manufacturing bakery products and the like to give these products a rounded shape.

In this type of support tray, it is possible to arrange a plurality of dough pieces spaced from each other in a single and same housing, the number of dough pieces received in a trough depending, on the one hand, on the length of said trough as well as, on the other hand, on the dimensions of the dough piece(s).

Thus known, from the international patent application published under number WO 2015/044588, is a support tray device for baking bakery or similar products comprising a frame on which a solid support material is fixed that is shaped so as to provide housings for receiving the dough pieces.

These housings extend parallel to each other from one edge to the opposite edge of the tray, and each of these housings consists of a solid sheet of arcuate section. In addition, the adjacent edges of the two contiguous housings are spaced apart so as to provide a continuous slot between them, so as to make the housings independent of each other.

Such a device has certain advantages, in particular that of being able to replace one of the housings in the event of deterioration of the latter without requiring the entire device to be replaced.

Another advantage of this support tray device comprising independent housings resides in the fact that the mechanical stresses applied to the tray are substantially reduced, in particular the deformations linked to the expansion of the material. Indeed, since the upper longitudinal edges of each housing are free, they can expand without constraint.

It should also be noted that the space between the cells or housings contained in a tray allows the air flow from the oven to pass through in order to guarantee optimal baking of all the dough pieces placed on the tray, including those located in the center of said tray.

In addition, using solid sheets to bake dough pieces should allow the bottom of the final product to have a smooth appearance, comparable to the appearance of products obtained following baking on stone.

However, the moisture and gas that are necessarily released at the underside of the dough pieces during the method for manufacturing bakery products cannot be discharged through a solid sheet. More particularly, it is during the fermentation phase, also called the proofing phase, that the product releases gases and moisture. Additionally, during the cooling step, the product also releases moisture. This phase, during which the product releases moisture after baking, when its crust has already formed, is also called sweating.

When baking is carried out on the same tray as that used in the fermentation phase, such a release of gas and moisture during the fermentation phase leads to the formation of cracks in the base of the product, which are observable after the baking phase and which ultimately give the bottom of the final product an unsightly appearance.

The release of moisture during the cooling phase in turn causes wetting and subsequent softening at the bottom of the product, in other words, an unsatisfactory final texture and appearance.

During the baking phase of the products, during a first baking step, water vapor is injected into the oven, then, in a second step, the atmosphere in the oven is dry. During baking, products also release moisture. However, the heat from the bottom of the oven is such that the dough piece is immediately “seized” and the crust is formed quickly enough to prevent the humidity, released at the bottom, from causing cracks to form. In other words, the atmosphere in the oven, hot and dry during the second baking stage, is conducive to absorption of the humidity released by the dough piece, contrary to the proofing stage in particular, during which the product remains in an already-humid atmosphere for a relatively long time.

However, in order to eliminate, or at least limit the presence of cracks, the products may be placed on trays that have been floured beforehand. The purpose of the flour is to absorb the evaporation of the water formed at the bottom of the product and, consequently, to prevent the appearance of water droplets at the interface of the tray and the product that would be likely to cause crack formation.

However, the flouring method has drawbacks, firstly that of the risk of flour accumulation on the production line. This accumulation is likely to lead to fouling of said line as well as deposits of flour in the oven, which may cause fires to start.

In addition, by implementing such a method, it is no longer possible to offer the consumer products with an unfloured bottom.

Another possibility consists in carrying out the fermentation stage of the dough pieces on trays made from plastic materials and which have been floured or covered with semolina beforehand, to prevent the appearance of cracks, before transferring said dough pieces into a trough of a support tray made of solid sheet metal for baking.

However, implementing such a possibility presupposes the presence and operation of complex mechanical systems for picking up and depositing dough pieces from the first tray used for the fermentation toward the second tray on which the baking will take place. Consequently, these picking up and depositing operations necessarily involve significant constraints, particularly in terms of managing the various sets of trays and maintaining the mechanical equipment.

In the state of the art, it is also known to use support trays having a metal sheet in which a plurality of perforations, or orifices, are formed, regularly distributed over its entire surface.

Traditionally, in the support trays of the state of the art comprising perforated sheets, obtained by removal of material, in particular by punching, the perforations are generally circular and their diameter is between 1.8 and 3 mm. The void percentage, or opening rate, at a tray is of the order of 40%. This opening rate may sometimes go up to 50% voids, or even more, such a rate being considered necessary for the support tray to allow satisfactory release, from below, of the moisture produced and discharged at the bottom of the dough piece during the fermentation stage.

Known for example, from the French patent application published under number FR 2756706, is a device for a bakery net comprising a support frame on which a metal sheet or perforated fabric is placed, shaped according to a sinusoidal profile so as to define a plurality of longitudinal channels constituting loaf receiving housings.

The metal sheet of the device here has a high void content greater than 25%, so as to allow even distribution of the heat and evacuation of the water during baking. In addition, it is covered with a thin layer of a non-stick polymer, sprayed on the sheet.

A removable flexible section of non-stick material shaped to be pressed into one of the longitudinal channels, also comprising perforations, is attached on this metal sheet.

Such trays have the advantage of allowing effective and optimal evacuation of the moisture and gases released from the dough pieces during certain stages of the manufacturing method, in particular fermentation and cooling, while ensuring good transmission of the air and baking heat.

However, although the products baked on such perforated trays, whether or not they incorporate a non-stick profile that is also perforated, are baked evenly and without the appearance of cracks due to the moisture released by the products, the perforations inevitably lead to marking the underside of the products.

Now, such marking gives the product an impression of industrial baking, which has a negative connotation in the eyes of consumers, the latter then unconsciously considering that the product is of poor quality, whereas a product with an appearance reminiscent of artisanal manufacture is generally sought.

Also known in the state of the art, from utility model application DE 9114841 and patent applications FR 1045958 and WO 01/65946, are baking trays or kitchen utensils made from rolled expanded metal. In the last document, the meshes of the expanded metal which is used are in the form of diamonds having relatively large dimensions, typically 6 mm by 20 mm, not allowing the problem which arises, mentioned in the preceding paragraph, to be solved.

### BRIEF SUMMARY OF THE INVENTION

The invention offers the possibility of overcoming, at least in part, the various drawbacks of the state of the art by proposing a support tray device intended to receive a plurality of dough pieces in order to convey them in particular through the fermentation and baking units of an installation for manufacturing bakery or similar products, said device allowing, at the same time, an optimal evacuation of the moisture released by the product, while avoiding an unsightly marking of the lower surface, or bottom, of the product coming in particular from the marks due to the perforations, and which would qualify the product as coming from industrial manufacture in the eyes of the consumers.

To this end, the present invention relates to a support tray device for transporting bakery, patisserie, viennoiserie or similar products through at least one processing unit of an installation for producing such products, said device comprising a frame on which at least one sheet of metallic material is fixed, said device being characterized in that said metal sheet consists of an expanded-metal sheet comprising micromeshes forming a metal lattice, said micromeshes having a passage opening of between 130 and 750 ?m and said expanded-metal sheet comprising, as a result of said micromeshes, a voids surface area representing between 17 and 60% of the total surface area of said sheet.

According to a very preferential feature, further allowing a reduction in the bottom marking of the products, said device is characterized in that said metal sheet consists of an expanded-metal sheet comprising micromeshes forming a metal lattice, said micromeshes having a passage opening between 130 and 250 ?m and said expanded-metal sheet comprising, as a result of said micromeshes, a voids surface area of between 17 and 45% of the total surface area of said sheet.

The expanded-metal sheet employed in the support tray device of the invention may advantageously be obtained by cutting and stretching a metal sheet.

In a preferred embodiment, said expanded-metal sheet comprising micromeshes is covered with a non-stick coating, the latter consisting either of polytetrafluoroethylene (PTFE), or of a sol-gel coating, or even of a silicone polymer.

Preferably, said expanded-metal sheet comprising micromeshes is made of a metallic material chosen from aluminum and stainless steel.

Said expanded-metal sheet may advantageously be shaped by bending so as to form at least one substantially half-circle cell constituting a recessed housing for receiving at least one dough piece or at least one loaf or the like, said cell extending longitudinally from one edge to the other of said support tray.

In an advantageous embodiment, the support tray device of the invention comprises a plurality of expanded-metal sheets each shaped by bending so as to form a substantially half-circle cell constituting a recessed housing for receiving at least one dough piece or at least one loaf or the like, each of the cells extending longitudinally from one edge to the other of said sheet between two longitudinal cell supports.

In a different embodiment, the surface of said expanded-metal sheet is flat or substantially flat in the support tray device of the invention.

The micromeshes of said expanded-metal sheet that equips the support tray device of the invention may have a diamond shape whose passage opening is 200 ?m and whose dimensions are 0.6 mm (LD—Long Diagonal)×0.4 mm (SD—Short Diagonal)×0.12 mm (W-Width of the strip)×0.10 mm (Th-thickness of the strip), said expanded-metal sheet having a voids surface area equal to 28% of the total surface area of said sheet.

The micromeshes of said expanded-metal sheet that equips the support tray device of the invention may also have a diamond shape whose passage opening is 200 ?m and whose dimensions are 0.75 mm (LD)×0.5 mm (SD)×0.20 mm (W)×0.15 mm (Th), said expanded-metal sheet having a voids surface area equal to 29% of the total surface area of said sheet.

The micromeshes of said expanded-metal sheet that equips the support tray device of the invention may further have a diamond shape whose passage opening is 250 ?m and whose dimensions are 0.85 mm (LD)×0.7 mm (SD)×0.20 mm (W)×0.15 mm (Th), said expanded-metal sheet having a voids surface area equal to 30% of the total surface area of said sheet.

The present invention has many advantages and in particular that of allowing, through the use of an expanded-metal sheet at a support tray device for bakery products and the like, a substantial reduction, or even a total or almost total elimination, of the marking of the underside of the product during baking compared with the marking resulting from the perforated trays that are currently used.

In addition, despite a not insignificant reduction in the opening rate compared with the sheets of the state of the art, effective moisture evacuation remains ensured by the micromeshes during certain stages of the manufacture of bread products, and especially during the fermentation and cooling stages.

The support tray device of the invention is also economical to produce, and has a particularly advantageous mechanical strength that lasts over time.

### BRIEF DESCRIPTION OF THE SEVERAL VIEWS OF THE DRAWINGS

Other features and advantages of the invention will emerge from the detailed description that follows of non-limiting embodiments of the invention, with reference to the appended figures.

FIG. 1 schematically illustrates a perspective view of a particular embodiment of a support tray device for bakery products or the like comprising a frame on which several cells are secured each consisting of an expanded-metal sheet comprising micromeshes and shaped so as to constitute a housing for at least one dough piece or the like, said cells extending longitudinally from one edge to the other of said tray device.

FIG. 2A is a schematic representation, in perspective view, of a particular embodiment of the frame of the support tray device of FIG. 1 and comprising a plurality of longitudinal cell supports.

FIG. 2B is a schematic representation, in perspective view, of a particular embodiment of a cell comprised by the support tray device of FIG. 1.

FIG. 3A is a schematic representation, in side view, of a detail of the support tray device illustrated in FIG. 1.

FIG. 3B is a schematic representation, in side view, of an enlarged detail of FIG. 3A.

FIG. 4A is an illustration of a photograph allowing the comparison of, on the left, a support tray device according to the present invention comprising an expanded-metal sheet comprising micromeshes and, on the right, a support tray device comprising a perforated metal sheet.

FIG. 4B is an illustration of a photograph of the bottom of a bakery product, in this case a baguette, obtained after baking the product on a support tray device according to the invention such as that shown on the left in FIG. 4A.

FIG. 4C is an illustration of a photograph of the bottom of a bakery product, in this case a loaf of bread, obtained after baking the product on a standard perforated tray of a support tray device, such as that shown on the right in FIG. 4A.

### DETAILED DESCRIPTION OF THE INVENTION

The present invention relates to the field of industrial bakery, and more particularly the manufacture of bakery, patisserie, viennoiserie or similar products through a suitable production installation comprising at least one processing unit for said products, and preferably a plurality of such units.

Thus, an installation for producing such products may in particular comprise at least one proofing oven and/or a baking oven and/or a cooler and/or a freezer.

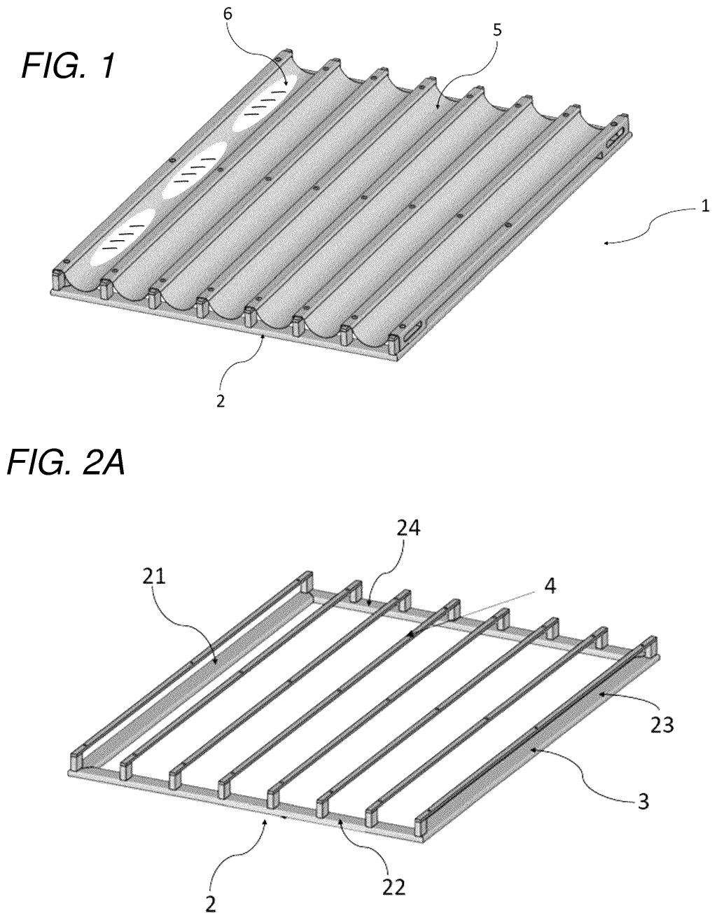

More particularly, and as shown in the attached FIG. 1, the present invention relates to a support tray device 1 for conveying bakery, patisserie, viennoiserie or similar products through these various processing units that make up a production installation for such products.

Indeed, generally, the dough pieces, resulting from a step of dividing the dough and possibly from a subsequent shaping step, are arranged on such a support tray device 1 in order to facilitate the handling of said dough pieces through the treatment units mentioned above.

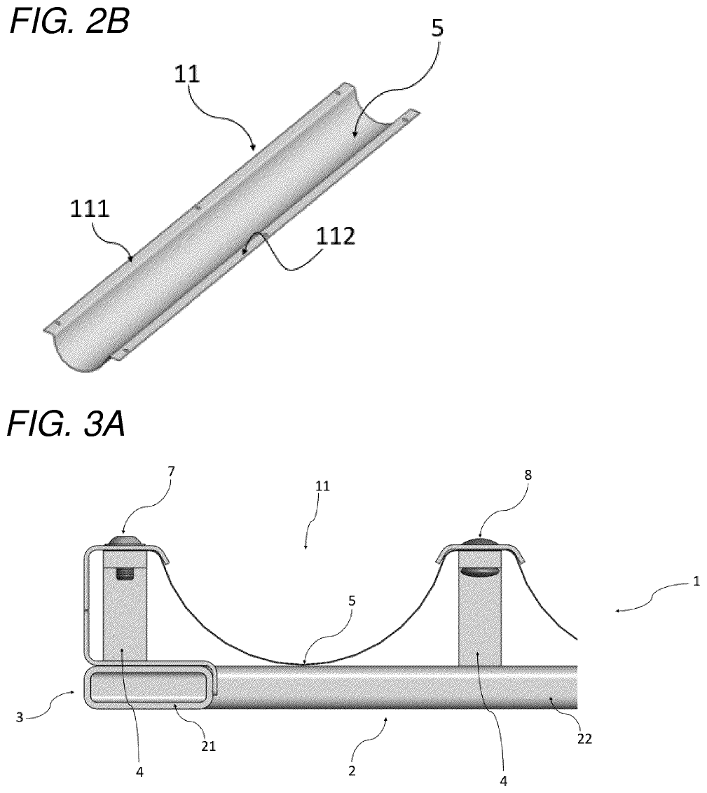

More specifically, according to the invention and with reference to FIGS. 1, 2A, 2B and 3, the support tray device 1 in particular comprises a frame 2, visible in detail and in full in FIG. 2A, which may, for example but non-limitingly, consist of an assembly of several metal tubular sections 21, 22, 23, 24 forming a framework 3, for example rectangular, in particular ensuring the rigidity of the entire device 1.

Preferably, at least two and preferably a plurality of juxtaposed transverse supports 4 may be mounted on this framework 3, each connecting two tubular sections 22, 24 that are parallel on the framework 3.

A support sheet 5 made from metallic material may be secured between two juxtaposed transverse supports 4, said support sheet advantageously being able to be shaped, for example by bending, so as to form a cell 11, or trough, that is substantially in the form of a half-circle, as in particular seen in detail in FIG. 2B. Preferably, two longitudinal edges 111, 112 extend the half-circle at each of its ends, and over the entire length of the cell 11.

Thus, this metal sheet 5 shaped like a cell can constitute a recessed housing intended to receive at least one dough piece 6, for example, said housing extending longitudinally between the two end edges of said sheet 5.

Depending on the length of the sheet of metallic material 5 and the size of said dough pieces 6, several dough pieces 6 may be received in a single and same housing.

Advantageously, this support sheet of metallic material 5 is secured, at the longitudinal edges 111, 112 of the cell 11, to said transverse supports 4 of the framework 3 by screwing and/or riveting by means, respectively, of screws 7 and/or rivets 8.

As seen in particular in FIG. 1, the support tray device 1 of the invention comprises a plurality of metal sheets 5, each shaped by bending to form a half-circle cell 11 for receiving one or more dough pieces 6.

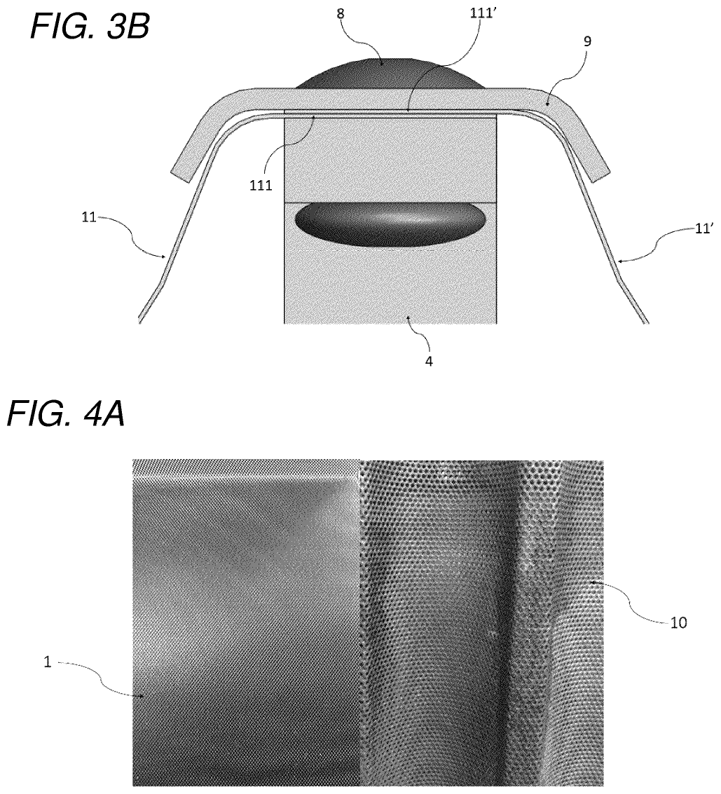

In this embodiment, and with reference to FIGS. 3A and 3B, each of the cells 11 is secured to two juxtaposed cell supports 4, two adjacent cells 11, 11′ being secured to a common cell support 4 by superimposing their respective longitudinal edges 111, 111′.

In addition, advantageously, a covering means 9, visible in FIG. 3B, and in particular in the form of a sheet metal portion, may be attached to the top of the superimposed longitudinal edges 111, 111′, in particular to ensure the fixing of the cells by riveting and/or by screwing.

In another embodiment, just as interesting, but not shown in the figures, of said support tray device 1 of the invention, an undulation may be conferred on a single metal support sheet 5 by bending, thus forming a plurality of recessed housings for receiving dough pieces 6, two adjacent housings being separated by the crest of a wave, in which one or more groove(s) is (are) possibly formed for a better passage of the flow of air between the housings.

It is also conceivable that the metal sheet or piece of sheet metal 5, in an embodiment not shown in the figures, is flat or substantially flat and secured to the frame 2 of the support tray device 1 of the invention, overlapping, at least in part, tubular sections forming said frame 2.

According to an essential feature of the device 1 of the bakery product support tray of the invention, the metal sheet 5, which is intended to support the dough pieces 6 in particular, is an expanded-metal sheet having relatively small micromeshes.

Such an expanded-metal sheet intended to equip the device 1 of the invention may be obtained by shearing or cutting, by means of knives for example, and stretching, generally simultaneous, of a solid metal sheet, so as to obtain an open mesh in the form of a three-dimensional metal lattice, without material removal. A step of flattening by rolling may optionally be carried out before or after stretching.

Generally, the micromeshes of the lattice are in the shape of diamonds leaving, for each diamond formed, a void surrounded by interconnected metal bars, defining the dimension of a passage opening, particles that have dimensions greater than this passage opening not being able to slip through the mesh. More particularly, once the smallest of the dimensions of a particle (length, width, diagonal, diameter, etc.) is greater than this passage opening, said particle cannot pass through the micromeshes.

According to the invention, said expanded-metal sheet 5 comprises micromeshes having a passage opening comprised between 130 and 750 μm, said expanded-metal sheet comprising, due to said micromeshes, a voids surface area comprised between 17 and 60% of the total surface area of said sheet.

A support tray device 1 having an expanded-metal sheet 5 with such characteristics, in terms of passage opening of the micromeshes 4 and of voids surface area of said sheet 5, allows the production of finished products of optimal quality, in particular at the bottom of these products.

In an even more advantageous embodiment of the device 1 of the invention, the expanded-metal sheet 5 that it comprises has micromeshes whose passage opening is between 130 and 250 μm while the proportion of voids, or open surface area, formed due to the micromeshes reaches between 17 and 45% compared to the total surface area of the expanded-metal sheet 5.

By means of such a device 1, the quality of the bottom of the products ultimately obtained is further improved, the marking thereof being almost non-existent.

In particular, the lower surface of said product, in other words the bottom thereof, which now only shows a marking that is difficult to discern with the eye and no cracks, the moisture having been correctly evacuated through the void contained by the meshes, while the micromeshes have imprinted their structure very little on the product.

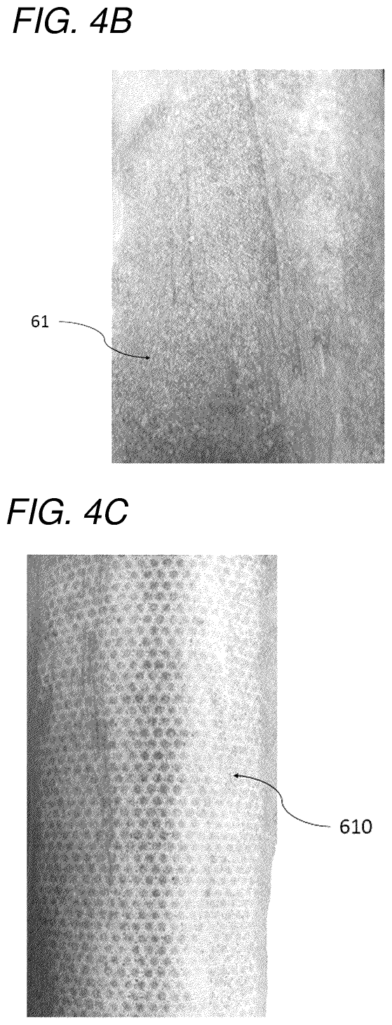

With reference to FIG. 4A to 4C, product baking tests, in this case baguettes, were carried out, on the one hand, with a support tray 10 comprising cells made with a perforated metal sheet, having perforations with a diameter equal to 1.8 mm and a void ratio equal to 40% and, on the other hand, with a support tray device 1 with cells made with an expanded-metal sheet, each of the two trays tested having a layer of a silicone non-stick coating.

The results obtained clearly show that, visually, the appearance of the bottom 61 of the product, that is to say, the underside of the product, is of much better quality when the latter is baked while resting on a support tray device 1 made from expanded metal (FIG. 4B), compared with the bottom 610 of the product obtained after baking on a perforated metal tray 10 (FIG. 4C).

In other words, using a support tray device 1 made with expanded metal, the bottom of the product is hardly marked during baking, or also pre-baking, and the finished product therefore has an appearance reminiscent of artisanal production. Such an appearance is visible in the photograph of FIG. 4B.

It should be noted that the diamond-shaped micromeshes of an expanded-metal sheet 5 making up the support tray device 1 of the invention are defined by at least four dimensions, namely the Long Diagonal (LD) of the diamond, its Short Diagonal (SD), the width of its Strip (W) and the Thickness of its strip (Th). Traditionally, the dimensions of a diamond micromesh are therefore specified as follows: LD×SD×W×Th.

The results obtained after baking and illustrated by the photograph of FIG. 4C were obtained by means of a support tray device 1 comprising an expanded-metal sheet 5 whose diamond-shaped micromeshes have the dimensions 0.85×0.7-0.20×0.15 mm, with a voids surface area equal to 30%, said micromesh having a passage opening equal to 250 μm.

However, other dimensions of micromesh allow optimal results to be obtained in terms of absence of marking at the bottom, while maintaining satisfactory evacuation of moisture, namely, according to examples of non-limiting dimensions:
0.6×0.4×0.12×0.10 mm, 28% voids surface area, passage 200 μm;
0.75×0.5×0.20×0.15 mm, 29% voids surface area, passage 200 μm;
0.85×0.7×0.15×0.15 mm, 45% voids surface area, passage 250 μm;
1.25×1×0.2×0.2 mm, 45% voids surface area, passage 550 μm;
1.5×1×0.15×0.15 mm, 56% voids surface area, passage 750 μm;
1.25×1×0.15×0.15 mm, 60% voids surface area, passage 600 μm;

It should also be noted that the micromeshes of the expanded-metal sheet 5 comprised by the support tray device 1 of the invention may have a shape different from that of a diamond, in particular a square shape, a rectangular shape, a hexagonal shape, or even a round shape.

Advantageously, said expanded-metal sheet 5 consists of an aluminum, steel or stainless steel sheet, the latter preferably having an extremely thin thickness, generally less than 0.3 mm.

Whatever the embodiment chosen, in particular in terms of the dimensions of the micromeshes and the nature of the metallic material, the expanded-metal sheet 5 may advantageously be covered by means of a non-stick coating in order to facilitate the removal of the dough pieces 6 after baking.

In a first embodiment, the non-stick treatment is carried out using polytetrafluoroethylene (or PTFE), this compound also being known under the registered trademark “Teflon.”

In a second embodiment, the non-stick coating consists of a sol-gel coating, which may be applied by any appropriate means known to those skilled in the art, and in particular by spraying.

Finally, in yet another embodiment, the non-stick coating consists of a silicone polymer, which may also be applied by spraying.

The support tray devices 1 according to the invention are particularly interesting and advantageous for the transport and rerouting of bread products within the various fermentation, baking and cooling units of an installation for manufacturing these products and between these various units.

Indeed, it is during these steps implemented in the method for manufacturing bakery and similar products that it is necessary to ensure optimum evacuation of the moisture formed on the underside of the product, in other words at the lower surface of the product that is in direct contact with said support tray 1, in order to avoid crack formation at this surface.

It has been demonstrated by the applicant that the characteristics of the support tray 1 of the invention allow the formation of visible spikes to be avoided on the lower surface of the dough piece 6 in contact with said tray 1, which the perforated trays traditionally used as support do not allow. By implementing the present support tray device 1, this avoids the formation of a marking that would negatively connote the finished product as much as possible.

Beyond this marked improvement, the marking of the bottom of the product obtained by the support tray 1 of the invention is similar to that of a product baked directly on a stone hearth. Thus, the visual difference in quality between a product cooked on a support of the tray type, and cooked directly on a hearth, is eliminated.

The invention also relates to a method of manufacturing a support tray device 1 as described above and in particular comprising a frame 2 on which at least one sheet of metallic material 5 is fixed, the latter consisting of an expanded-metal sheet.

The manufacturing method comprises at least the following steps:

Openings are made, preferably by cutting and stretching, generally simultaneously, in a sheet of metallic material, advantageously of stainless steel, said sheet preferably having a thickness of less than 0.3 mm;

Optionally, said sheet of metallic material 5 is shaped, in particular by bending so as to form at least one cell 11, or a plurality of cells, the cell or each of the cells thus formed being substantially in the form of a half-circle and constituting a recessed housing for receiving at least one dough piece or at least one loaf or the like, said cell 11 extending longitudinally from one edge to the other of said support tray 1;

Said sheet of metallic material 5 is assembled on said frame 2.

In an advantageous embodiment of the method of the invention, either before the step of assembling the sheet of metallic material 5 on the frame 2, or after this step, a layer of non-stick coating is deposited on the surface of this sheet, said coating being chosen from polytetrafluoroethylene, silicone, or a sol-gel coating.

Preferably, a layer of non-stick coating having a thickness less than or equal to 500 μm is deposited, so as to avoid clogging of the micromeshes of the expanded-metal sheet.

This step of depositing the non-stick coating may be carried out by any means known to those skilled in the art, and in particular by spraying.

Optionally, prior to the step during which a layer of non-stick coating is deposited on the surface of the sheet of metallic material 5, at least one surface treatment of said sheet is carried out.

This surface treatment may in particular consist of a treatment by brushing or a plasma treatment that aims to facilitate the adhesion of the non-stick coating that will be subsequently deposited on the surface of the sheet of metallic material.

In particular, carrying out a plasma treatment allows a good roughness to be imparted to said sheet of metallic material without deforming it.

Of course, the invention is not limited to the examples illustrated and described above, which may have variants and modifications without departing from the scope of the invention.

1. A support tray device for transporting products through at least one processing unit of an installation for producing the products, the device comprising:
a frame; and
at least one sheet of metallic material fixed on said frame,
wherein the sheet is comprised of an expanded-metal sheet being comprised of micromeshes forming a metal lattice,
wherein said micromeshes have a passage opening of between 130 and 750 μm, and
wherein said expanded-metal sheet comprises, as a result of said micromeshes, a voids surface area representing between 17 and 60% of the total surface area of said sheet.

2. The support tray device according to claim 1, wherein said micromeshes have a passage opening between 130 and 250 μm, and wherein said expanded-metal sheet comprises, as a result of said micromeshes, a voids surface area of between 17 and 45% of the total surface area of said sheet.

3. The support tray device, according to claim 1, wherein the expanded-metal sheet being comprised of micromeshes is covered with a non-stick coating.

4. The support tray device, according to claim 3, wherein said non-stick coating is comprised of polytetrafluoroethylene.

5. The support tray device, according to claim 3, wherein said non-stick coating is comprised of a sol-gel coating.

6. The support tray device, according to claim 3, wherein said non-stick coating is comprised of a silicone polymer.

7. The support tray device, according to claim 1, wherein said expanded-metal sheet is comprised of a metallic material chosen from aluminum and stainless steel.

8. The support tray device, according to claim 1, wherein said expanded-metal sheet is shaped by bending so as to form at least one substantially half-circle cell being comprised of a recessed housing for receiving at least one dough piece or at least one loaf, the cell extending longitudinally from one edge to the other of said support tray.

9. The support tray device according to claim 1, further comprising: a plurality of expanded-metal sheets each shaped by bending so as to form a substantially half-circle cell being comprised of a recessed housing for receiving at least one dough piece or at least one loaf, each of the cells extending longitudinally from one edge to the other of said sheet between two longitudinal cell supports.

10. The support tray device, according to claim 1, wherein the surface of said expanded-metal sheet is flat or substantially flat.

11. The support tray device, according to claim 1, wherein the micromeshes of said expanded-metal sheet has a diamond shape whose passage opening is 200 μm and whose dimensions are 0.6 mm (LD—Long Diagonal)×0.4 mm (SD—Short Diagonal)×0.12 mm (W-Width of the strip)×0.10 mm (Th-thickness of the strip), said expanded-metal sheet having a voids surface area equal to 28% of the total surface area of said sheet.

12. The support tray device, according to claim 1, wherein the micromeshes of said expanded-metal sheet has a diamond shape whose passage opening is 200 μm and whose dimensions are 0.75 mm (LD)×0.5 mm (SD)×0.20 mm (W)×0.15 mm (Th), said expanded-metal sheet having a voids surface area equal to 29% of the total surface area of said sheet.

13. The support tray device, according to claim 1, wherein the micromeshes of said expanded-metal sheet has a diamond shape whose passage opening is 250 μm and whose dimensions are 0.85 mm (LD)×0.7 mm (SD)×0.20 mm (W)×0.15 mm (Th), said expanded-metal sheet having a voids surface area equal to 30% of the total surface area of said sheet.
